(19) United States
(12) Patent Application Publication
(10) Pub. No.: US 2006/0244229 A1
(43) Pub. Date: Nov. 2, 2006

(54) DOLLY ASSEMBLY FOR SUPPORTING AND TRANSPORTING OBJECTS

(76) Inventor: Cliff Padgett, Houston, TX (US)

Correspondence Address: KEELING PATENTS AND TRADEMARKS, 3310 KATY FREEWAY, SUITE 100, HOUSTON, TX, 77007, US

(21) Appl. No.: 11/380,889

(22) Filed: Apr. 28, 2006

Related U.S. Application Data
(60) Provisional application No. 60/675,633, filed on Apr. 28, 2005.

(51) Int. Cl. B62B 5/00

(52) U.S. Cl. 280/79.11

(57) ABSTRACT

The present invention is a dolly comprising a plurality of stems integrally formed with the dolly body. The plurality of integrally formed stems extend downwardly from the body. An equal number of collars are concentric with the plurality of stems, wherein the collars are also integrally formed with the body. The body, stems, and collars are made of a durable material capable of withstanding large weights. An equal number of wheel casters are configured to be engageable with and freely rotatable about the plurality of stems.

### CROSS-REFERENCE TO RELATED APPLICATIONS

This application claims the benefit of U.S. Provisional Patent Application No. 60/675,633 entitled, “Plant Dolly,” filed on Apr. 28, 2005 in the United States Patent and Trademark Office.

### STATEMENT REGARDING FEDERALLY SPONSORED RESEARCH OR DEVELOPMENT

Not Applicable.

### BACKGROUND OF THE INVENTION

1. Field of the Invention.

The present invention relates to dollies for supporting and moving objects, and more particularly to an inexpensive plant dolly comprised of integrally formed body and stems.

2. Description of the Related Art.

Prior art in the field of plant dollies have included plastic bodies with separate metal stems for attaching casters. The separate metal stems provided reinforced support for heavy loads the plant dolly may support. While this design is effective in providing a durable load-bearing plant dolly, it is not cost effective because the metal stems are expensive compared to the remaining components of the plant dolly.

U.S. Pat. No. 1,834,617, issued to Harpine et al. on Dec. 1, 1931 discloses a caster assembly having two cups arranged such that an outer cup, integrally formed with the caster housing, forms a socket for an inner cup located on the bottom of a leg of a piece of furniture. A stem, or shank, is secured to the caster housing and is held within a circumferential collar within the furniture leg. Downward force on the furniture leg causes the inner cup to sit within the outer cup, thereby distributing the downward force around the inner cup wall to the bottom of the outer cup. Simultaneously, the top of the outer cup wall rests on the bottom of the furniture leg.

U.S. Pat. No. 2,025,448, issued to Hebbinghaus on Dec. 25, 1935 discloses a furniture caster having a stem affixed to a fork, which holds the roller. The fork is slidingly retained within an inner sleeve, the fork being biased to hold the roller in a lowered position wherein furniture may be moved. The inner sleeve is fixedly retained within a bell having an aperture through which the roller passes when the furniture is being moved. Pressure to the furniture pushes the roller upward so that the furniture rests on the bell. A spring pushes two ball bearings outwardly apart toward respective cavities to provide a detent for the position in which the rollers are in a lowered position.

U.S. Pat. No. 4,283,810 issued to Demrick on Aug. 18, 1981 discloses a caster assembly having a socket to receive a swivel stem. The stem disclosed has an integrally-formed flange that may abut the top of socket. Nothing is disclosed about the assembly adjoined to the stem.

It would therefore be advantageous to provide a plant dolly that could be constructed with an integrally formed body and stems.

### BRIEF SUMMARY OF THE INVENTION

The present invention addresses the aforementioned need. According to one embodiment of the invention, a body, with a plurality of integrally formed stems extending downwardly from the body. An equal number of collars are concentric with the plurality of stems, wherein the collars are also integrally formed with the body. The body, stems, and collars are made of a durable material capable of withstanding large weights. An equal number of wheel casters are engageable with the plurality of stems. The wheel casters are configured such that the wheel casters are freely rotatable about the plurality of stems.

Other features and advantages of the invention will be apparent from the following description, the accompanying drawing and the appended claims.

### BRIEF DESCRIPTION OF THE DRAWINGS

FIG. 1 is a side view of an unloaded plant dolly.

FIG. 2 is a side view of a plant dolly supporting a load-bearing object.

FIG. 3A is a detailed view of the bottom surface of the plant dolly with integrally formed stems.

FIG. 3B is a zoomed view of the integrally formed stem and collar.

FIG. 4 is a side view of the wheel guard.

FIG. 5 is a bottom view of the wheels and wheel guard.

FIG. 6 is a detailed view of the bottom surface of an alternate embodiment of the plant dolly.

FIG. 7 is a cross section of the alternate embodiment of the plant dolly and stem.

### DESCRIPTION OF THE INVENTION

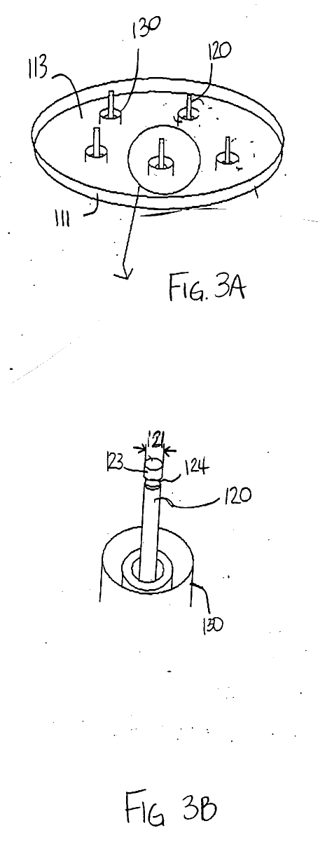

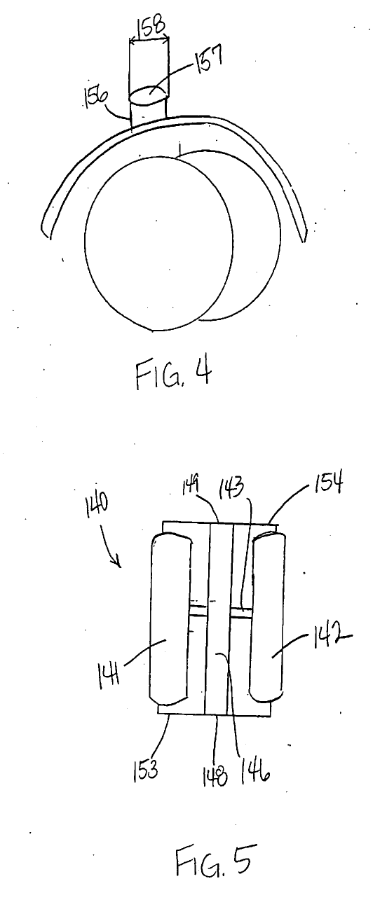

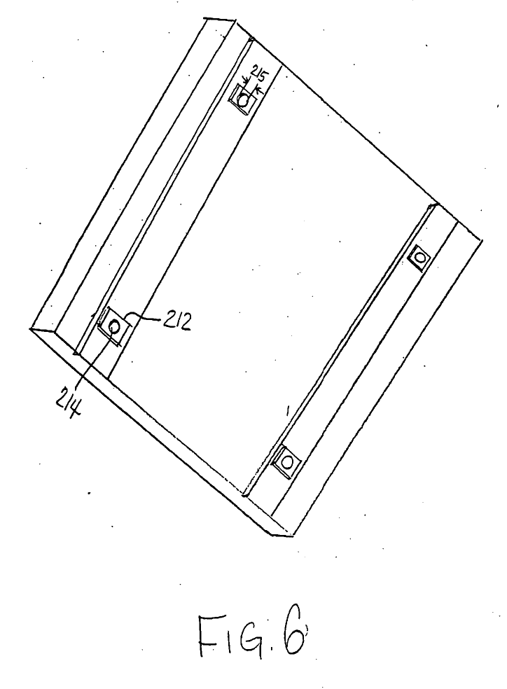

The preferred embodiment of dolly 100 is depicted in FIGS. 1-3B. Dolly 100 is comprised of body 110, stem 120, collar 130, wheel 140, and wheel guard 150.

Body 110 is defined by body perimeter 111, which circumscribes body 110. Body 110 has body top surface 112 and body bottom surface 113. Body top surface 112 is planar, thereby providing a level surface capable of supporting an object. Similarly, body bottom surface 113 is planar. Body 110 can be constructed out of plastic, wood, or other durable materials known in the art, so long as the material provides sufficient strength for supporting a load-bearing object.

A plurality of stems 120 extend downwardly perpendicular with respect to body bottom surface 113. Stems 120 provide support for body 110. Stem 120 is preferably cylindrical, with a stem diameter 121. Stem 120 terminates at stem upper terminal end 122 and stem lower terminal end 123. Stem upper terminal end 122 is proximate body bottom surface 113 and is integrally attached to body bottom surface 113. Stem notch 124 is formed into stem 120 proximate stem lower terminal end 123. Stem notch 124 circumscribes stem 120, thereby providing a surface for attaching wheel 140 to stem 120. Body 110 and stem 120 are preferably a unitary structure simultaneously formed from a molded plastic.

In the preferred embodiment, collar 130 extends downwardly from body bottom surface 113. Collar 130 is circular and encompasses stem 120. Collar 130 is typically concentric with stem 120. Preferably, collar 130 is formed of a molded plastic, simultaneously with body 110. Alternatively, collar 130 can be formed of similarly rigid material known in the art and can be fixedly attached to body bottom surface 113 subsequent to unitarily forming body 110 and stem 120.

Referring to FIGS. 1, 2, and 5, wheel guard 150 is comprised of guard fender 151, guard crossbar 146, and guard arm 156. Guard fender 151 is semi-circular and has a fender diameter 152. Guard fender 151 terminates at first fender terminal end 153 and second fender terminal end 154. First fender terminal end 153 and second fender terminal end 154 are integrally connected by guard crossbar 146, wherein guard crossbar 146 is perpendicular to first fender terminal end 153 and second fender terminal end 154. Guard crossbar 146 provides a means of connecting wheel 140 to wheel guard 150. This connection occurs through an orifice (not shown) in guard crossbar 146.

Guard arm 156 upwardly extends from guard fender 151 and is preferably offset from fender apex 155. Guard arm 156 is cylindrical and defines a guard arm socket 157. Guard arm socket 157 has an arm socket diameter 158, which is larger than stem diameter 121. Guard arm socket 157 receives stem 120, wherein stem lower terminal end 123 is inserted into guard arm socket 157 until stem notch 124 engages with arm socket latch (not shown). Once engaged, wheel guard 150 is freely rotatable about stem 120.

Wheel 140 provides movement to dolly 100. Wheel 140 comprises first wheel member 141 and second wheel member 142. First wheel member 141 and second wheel member 142 are connected by wheel journal 143. First wheel member 141 is positioned proximate crossbar first side 148 and second wheel member 142 is positioned proximate crossbar second side 149, with wheel journal 143 extending through the orifice (not shown) in guard crossbar 146. Wheel journal 143 intersects wheel center point 144 of first wheel member 141 and second wheel member 142. Wheel journal 143 provides a rotational axis for first wheel member 141 and second wheel member 142.

FIG. 1 depicts dolly 100 with no load applied to body 110. When dolly 110 is not bearing a load, collar 130 and fender 151 do not interact. Therefore, the configuration of collar 130 and fender 151 provides clearance 170. While clearance 170 can be of any distance, clearance 170 should not be excessive. If clearance 170 is too great, stem 120 will bear the entire load exerted against body 110, possibly resulting in breaking stem 120. Therefore, clearance 170 is preferably between 0.015 inches and 0.070 inches.

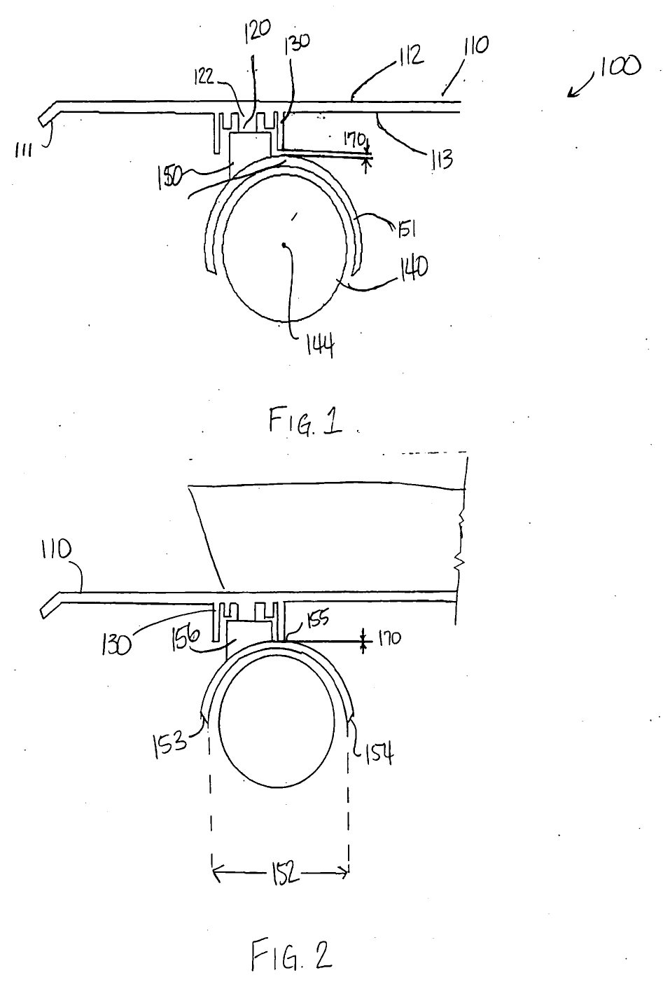

FIG. 2 depicts dolly 100 with a load applied to body 110. The load exerts a normal force against body 110, thereby resulting in compressing body 110 a distance equal to or less than clearance 170. When the load is applied to body 110, collar 130 compresses. If a large enough load is exerted against body 110, collar 130 will contact fender 151 approximate fender apex 155. Therefore, when dolly 100 bears a load exceeding a predetermined weight, clearance 170 is zero. When collar 130 contacts fender 151, fender 151 provides additional support for body 10, thereby distributing the normal forces and relieving stress from stems 120.

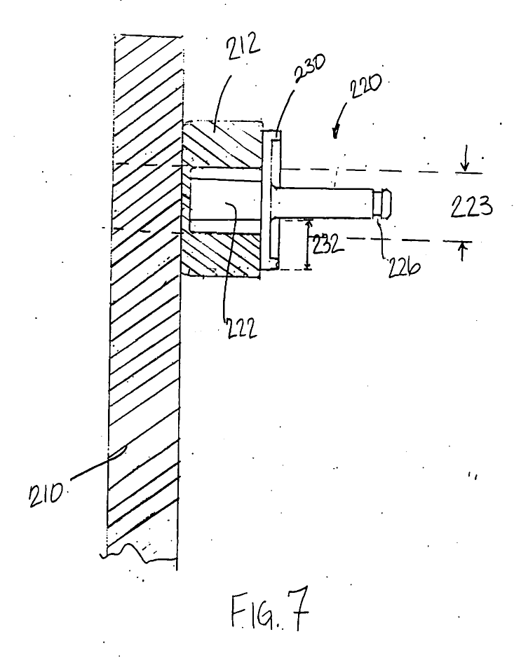

An alternative embodiment is depicted in FIGS. 6-7, wherein stem 220 is formed separately from body 210. In the alternative embodiment, stem 220 is fixedly attached to body 210. This configuration is particularly desireable when body 210 is formed of a natural material, such as wood.

As seen in FIG. 6, body 210 has a plurality of body mounting surfaces 212, which are configured for receiving a plurality of stems 220. Body mounting surface 212 may be of any material, but is preferably 33% glass filled nylon Type 6/6. Body mounting surface 212 may be fixedly attached to body 210, as seen in FIG. 6. Alternatively, body mounting surface 212 may be integrally formed with body 210 (not shown). Body mounting surface 212 has a body orifice 214 passing therethrough. Body orifice 214 provides an insertion point for stem 220. Body orifice 214 is preferably circular, and has a body orifice diameter 215. Alternatively, body orifice 214 can be of any shape known in the art.

Referring to FIGS. 6 and 7, stem 220 is integrally formed by stem engaging end 222, stem notch 226, and collar 230. Stem engaging end 222 is preferably comprised of a plurality of ribs 223 oriented about stem 220 proximate stem engaging end 222. Ribs 223 are configured for insertion into body orifice 214 and engagement with body 210. Stem engaging end 222 has an engaging end diameter 223. Engaging end diameter 223 is sized to fit within body orifice 214; thus, engaging end diameter 223 is smaller than body orifice diameter 215. Stem notch 226 is located distal stem engaging end 222. Stem notch 226 provides a surface for engaging stem 220 with wheel 140 (seen in FIG. 1). In the alternative embodiment, collar 230 replaces collar 130, depicted in FIG. 1. Collar 230 circumscribes stem 220 and is located between stem engaging end 222 and stem notch 226. Collar 230 extends a collar distance 232 from stem 220. Collar distance 232 should be sufficient to extend to at least the apex of fender 151. Similar to collar 130 depicted in FIG. 1, collar 230 distributes weight exerted against dolly 100.

The foregoing description of the invention illustrates a preferred embodiment thereof. Various changes may be made in the details of the illustrated construction within the scope of the appended claims without departing from the true spirit of the invention. The present invention should only be limited by the claims and their equivalents.

What is claimed is:

1. A dolly for moving objects said dolly comprising:
a body, said body having a body top surface and a body bottom surface;
said body top surface configured to support said objects;
at least one stem extending downwardly from said body bottom surface;
said at least one stem integrally formed with said body;
at least one wheel;
said at least one wheel configured to pivotally rotate about an axis;
said at least one wheel configured for engagement with said at least one stem.

2. The dolly of claim 1, further comprising:
at least one collar integrally formed with said body;
said at least one collar extending downwardly from said body; and
said at least one collar concentric with said at least one stem.

3. The dolly of claim 2, further comprising:
said at least one wheel at least partially circumscribed by at least one guard;
said at least one guard has an apex; and
said apex does not contact said at least one collar when said body top surface does not support said object.

4. The dolly of claim 2, further comprising;
said at least one wheel at least partially circumscribed by at least one guard;
said at least one guard has an apex; and
said apex contacts said at least one collar when said body top surface supports said object.

5. The dolly of claim 2, further comprising:
said at least one stem has a stem upper end and a stem lower end;
said at least one stem has a stem notch; and
said at least one wheel is enageable with said at least one stem at said stem notch.

6. A dolly for moving objects, said dolly comprising:
a body, said body having a body top surface and a body bottom surface;
said body top surface configured to support said objects;
at least one stem extending downwardly from said body bottom surface;
said at least one stem integrally formed with said body;
at least one collar integrally formed with said body;
said at least one collar extending downwardly from said body;
said at least one collar concentric with said at least one stem;
at least one wheel;
said at least one wheel configured to pivotally rotate about an axis;
said at least one wheel engageable with said at least one stem;
said at least one stem has a stem upper end and a stem lower end;
said at least one stem has a stem notch;
said at least one wheel is enageable with said at least one stem at said stem notch;
said at least one wheel at least partially circumscribed by at least one guard;
said at least one guard has an apex;
said apex does not contact said at least one collar when said body top surface does not support said object; and
said apex contacts said at least one collar when said body top surface supports said object.
